(19) United States
(12) Patent Application Publication
(10) Pub. No.: US 2014/0166051 A1
(43) Pub. Date: Jun. 19, 2014

(54) APPARATUS, SYSTEM, AND METHOD FOR SEPARATING GASES AND MITIGATING DEBRIS IN A CONTROLLED PRESSURE ENVIRONMENT

(71) Applicant: KLA-Tencor Corporation, Milpitas, CA (US)

(72) Inventors: Karl R. Umstadter, Livermore, CA (US); Michael P. Kanouff, Livermore, CA (US); Rudy Garcia, Union City, CA (US); Mike Romero, San Jose, CA (US)

(73) Assignee: KLA-Tencor Corporation, Milpitas, CA (US)

(21) Appl. No.: 14/105,986

(22) Filed: Dec. 13, 2013

Related U.S. Application Data
(60) Provisional application No. 61/738,342, filed on Dec. 17, 2012.

(51) Int. Cl. B05B 1/00

(52) U.S. Cl. CPC B05B 1/005
USPC 134/21; 239/589; 15/347; 134/22.18; 206/525

(57) ABSTRACT

An assembly, including: a nozzle including a first chamber with a first orifice arranged to receive a stream of gas; a second chamber with a second orifice to emit the stream; a throat connecting the nozzle chambers; and a collector including: top and bottom walls with first and second openings; a third chamber bounded by the top and bottom walls and including a third opening connected to the second orifice to receive the stream; and a fourth opening. The first chamber tapers from the first orifice to the throat. The second chamber expands in size from the throat to the second orifice. The third chamber expands in size from the third opening to the fourth opening. The collector is arranged to: entrain, in the stream, debris entering the third chamber through first or second opening; and emit the stream, with the entrained debris, from the fourth opening.

### CROSS-REFERENCE TO RELATED APPLICATIONS

This application claims the benefit under 35 U.S.C. §119(e) of U.S. Provisional Patent Application No. 61/738,342, filed Dec. 17, 2012, which application is incorporated herein by reference in its entirety.

### TECHNICAL FIELD

The present disclosure relates to apparatus, a system and methods for separating gases and mitigating debris in a controlled pressure environment. In particular, the present disclosure relates to apparatus, system and method for generating a controlled gas stream with nozzles and passing the gas stream through a collector to entrain debris associated with generation of extreme ultra-violet light.

### BACKGROUND

Plasma sources are used to generate light, such as extreme ultra-violet (EUV) for use in semi-conductor applications, such as semi-conductor inspection systems in low pressure environments. Typically, the light is transmitted in an axial direction to, for example, a chamber including optical components for the inspection station. A by-product of the light generation is debris that can migrate into sensitive portions of the inspection system, for example, degrading light quality or contaminating optical components, adversely impacting the function and service life of the optical components and/or requiring more frequent purging of the inspection system, all of which are undesirable.

S R Mohanty, T Sakamoto, Y Kobayashi, et al., disclose a gas curtain to address debris from a EUV source. The design uses an annular nozzle to create an annular curtain coaxial with the source (S R Mohanty, T Sakamoto, Y Kobayashi, et. al., “Influence of electrode separation and gas curtain on extreme ultraviolet emission of a gas jet z-pinch source”, Applied Physics Letters, 89, 041502, 2006). The method used by Mohanty et al. does not stop debris travelling in the axial direction from the source. Thus, the method of Mohanty et al. is unsuitable for controlling debris associated with the axial transmission of the EUV emission. For example, for a semi-conductor inspection system, the method of Mohanty et al. cannot prevent debris from the EUV light source from entering the chamber in an axial direction and contaminating the optical components in the chamber.

### SUMMARY

According to aspects illustrated herein, there is provided a nozzle for producing a controlled gas stream in a low pressure environment, including: a first chamber with a first orifice arranged for connection to a source of gas and to receive a stream of gas from the source; a second chamber with a second orifice arranged to emit the stream; a throat connecting the first and second chambers; and a longitudinal axis extending from the first orifice to the second orifice in a first direction. The first chamber tapers from the first orifice to the throat. The second chamber expands in size from the throat to the second orifice.

According to aspects illustrated herein, there is provided a collector for entraining and ejecting debris in a gas flow for a low pressure system, including: a top wall, a bottom wall, and first and second side walls connecting the top and bottom walls; first and second openings in the top and bottom walls, respectively; and a first chamber: formed by the top wall, the bottom wall, and the first and second side walls; including a third opening arranged to receive a stream of gas and a fourth opening; and expanding in size from the first opening to the second opening. The collector includes a longitudinal axis extending in a first direction from the third opening to the fourth opening. The collector is arranged to: entrain, in the stream, debris entering the first chamber through the first or second opening; and emit the stream, with the entrained debris, from the fourth opening.

According to aspects illustrated herein, there is provided an assembly for removing debris from a controlled pressure environment, including: a nozzle including a first chamber with a first orifice arranged for connection to a source of gas and to receive a stream of gas from the source a second chamber with a second orifice arranged to emit the stream; a throat connecting the first and second chambers; and a collector including top and bottom walls with first and second openings, respectively, a third chamber bounded in part by the top and bottom walls and including a third opening connected to the second orifice and arranged to receive the stream, and a fourth opening; and, a longitudinal axis passing through the first and second orifices and the third and fourth openings in a first direction. The first chamber tapers from the first orifice to the throat. The second chamber expands in size from the throat to the second orifice. The third chamber expands in size from the third opening to the fourth opening. The collector is arranged to: entrain, in the stream, debris entering the third chamber through first or second opening; and emit the stream, with the entrained debris, from the fourth opening.

According to aspects illustrated herein, there is provided a method for removing debris from a controlled pressure environment, including: flowing gas, in a first direction, through a first chamber for a nozzle while simultaneously reducing, along the first direction, a first area, in second and third directions orthogonal to the first direction, of a stream of the gas in the first chamber; flowing the gas through a throat connecting the first chamber to a second chamber for the nozzle; flowing the gas, in the first direction, through the second chamber while simultaneously increasing, along the first direction, a second area, in the second and third directions, of the steam of the gas in the second chamber; flowing the gas from the second chamber into a third chamber for a collector; flowing the gas through the third chamber in the first direction, while simultaneously increasing, along the first direction, a third area, in the second and third directions, of the stream of the gas in the third chamber; entraining, in the stream of the gas, debris located in the third chamber; and emitting, in the first direction, the stream of the gas with the entrained debris from the third chamber through a first opening of the collector.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a top view of a nozzle for producing a controlled gas stream in a low pressure environment;

FIG. 2 is a side view of the nozzle in FIG. 1;

FIG. 3 is cross-sectional view generally along line 3-3 in FIG. 1;

FIG. 4 is a cross-sectional view generally along line 4-4 in FIG. 2;

FIG. 5 is a front view of the nozzle in FIG. 1 showing an exit orifice;

FIG. 6 is a top view of a nozzle for producing a controlled gas stream in a low pressure environment;

FIG. 7 is a side view of the nozzle in FIG. 6;

FIG. 8 is cross-sectional view generally along line 8-8 in FIG. 6;

FIG. 9 is a cross-sectional view generally along line 9-9 in FIG. 7;

FIG. 10 is a front view of the nozzle in FIG. 6 showing an exit orifice;

FIG. 11 is a top view of a collector for entraining and ejecting debris in a gas flow for a low pressure system;

FIG. 12 is a side view of the collector in FIG. 11;

FIG. 13 is cross-sectional view generally along line 13-13 in FIG. 11;

FIG. 14 is a cross-sectional view generally along line 14-14 in FIG. 12;

FIG. 15 is a top view of an assembly for mitigating contamination in a low pressure environment;

FIG. 16 is a side view of the assembly in FIG. 15;

FIG. 17 is cross-sectional view generally along line 17-17 in FIG. 15;

FIG. 18 is a cross-sectional view generally along line 16-16 in FIG. 15;

FIGS. 19A and 19B are graphs showing calculated and actual performance of the nozzle in FIGS. 1 through 5; and,

FIGS. 20A and 20B are graphs showing calculated and actual performance of the nozzle in FIGS. 6 through 10.

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

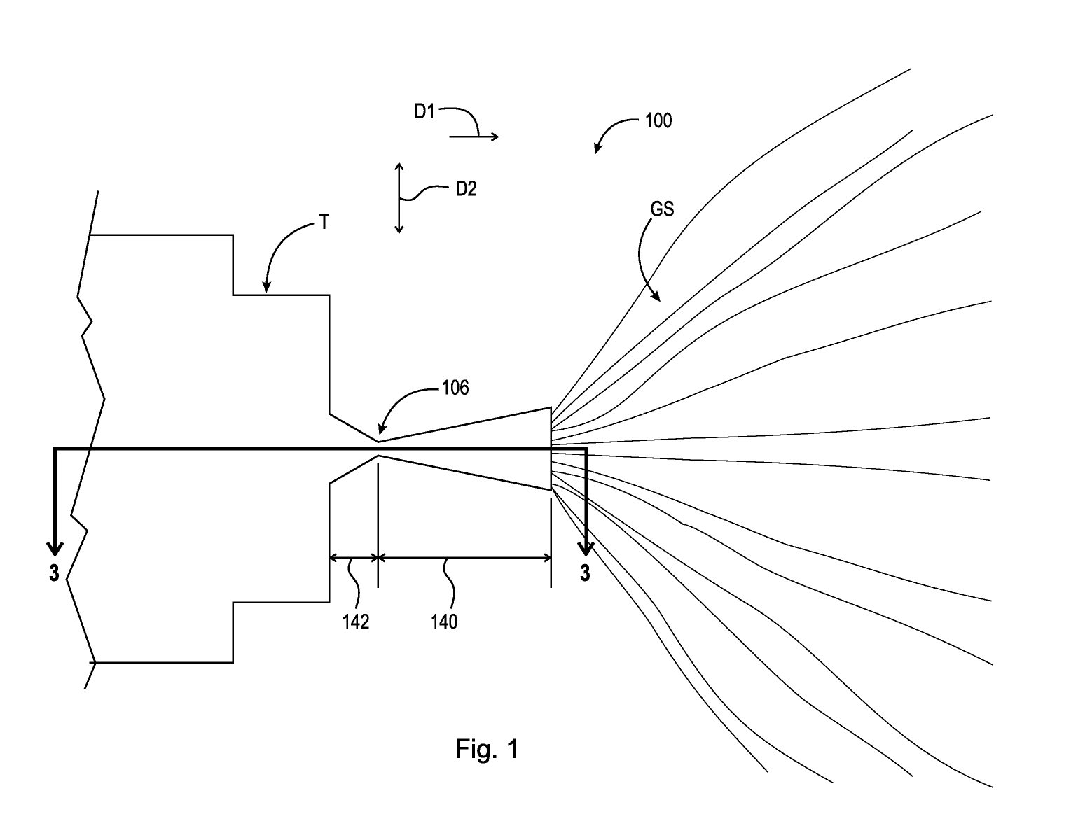

FIG. 1 is a top view of nozzle 100 for producing a controlled gas stream in a low pressure environment.

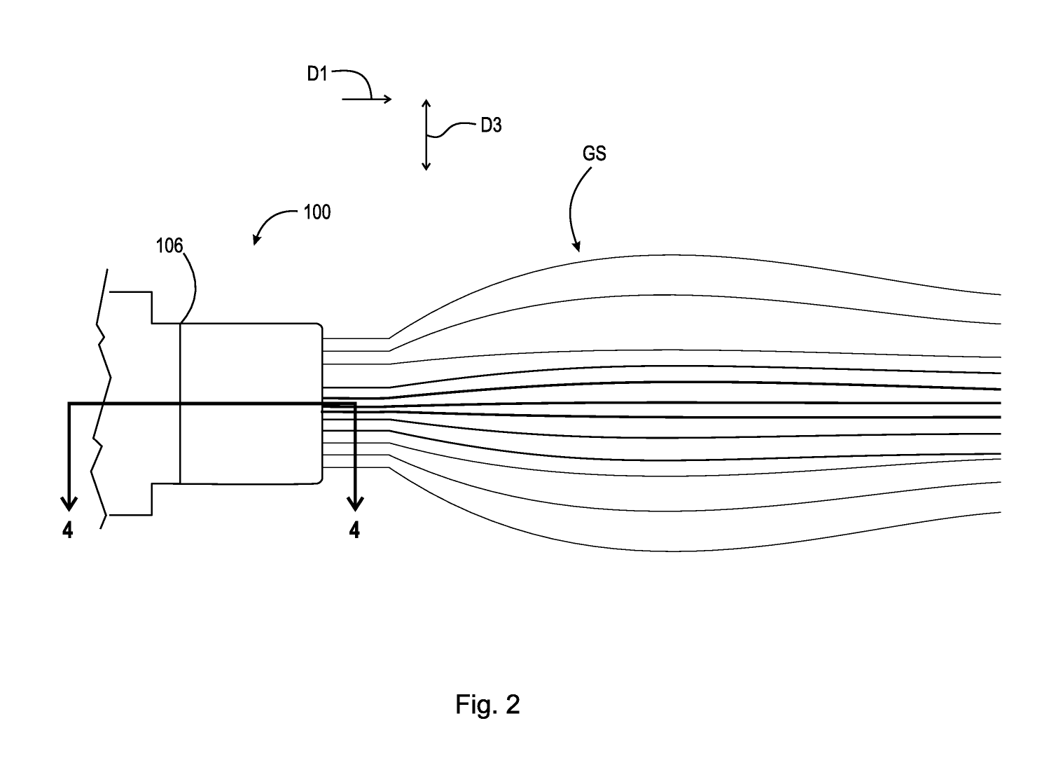

FIG. 2 is a side view of nozzle 100 in FIG. 1.

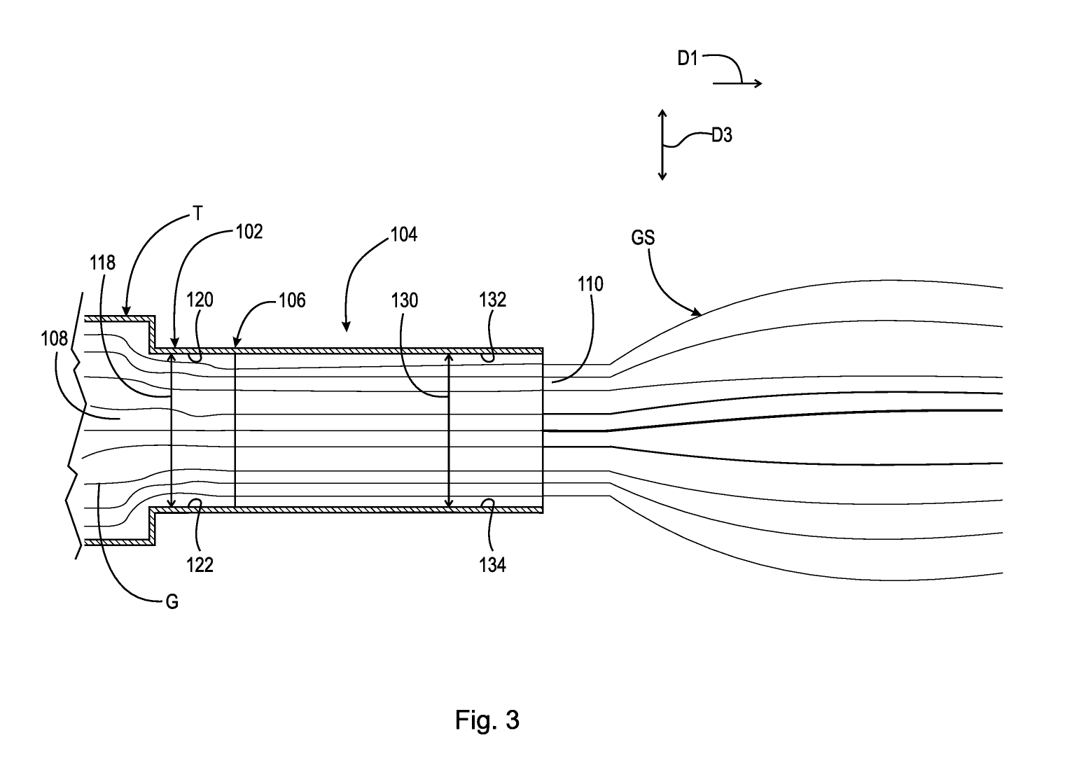

FIG. 3 is cross-sectional view generally along line 3-3 in FIG. 1.

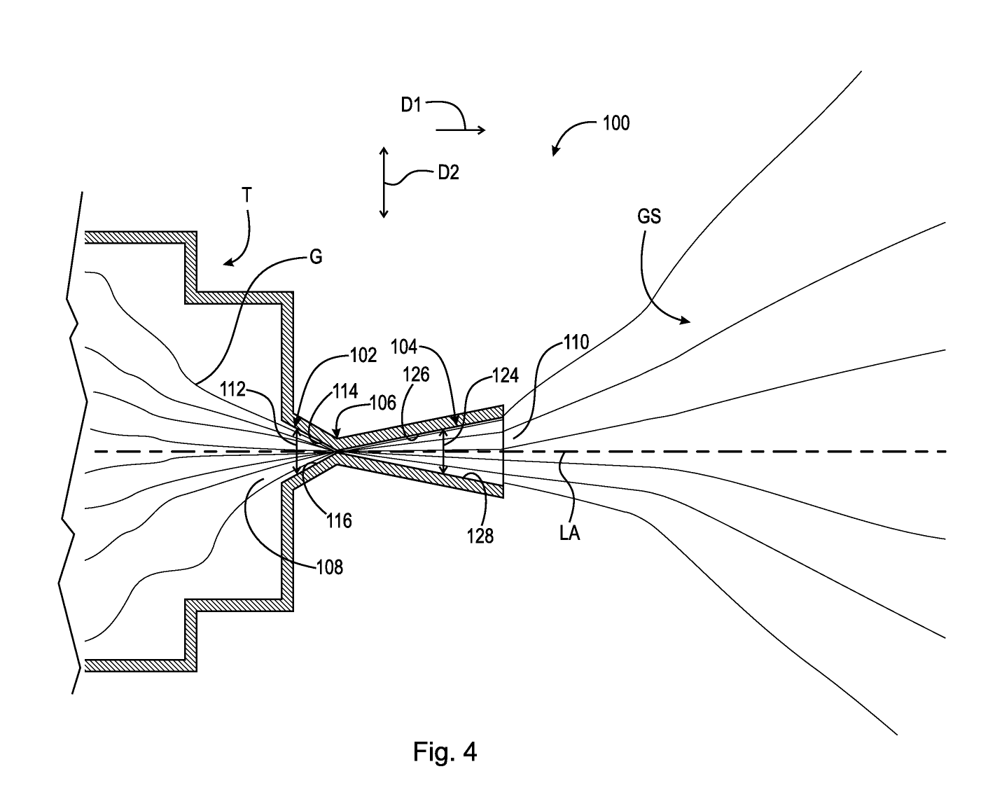

FIG. 4 is a cross-sectional view generally along line 4-4 in FIG. 2.

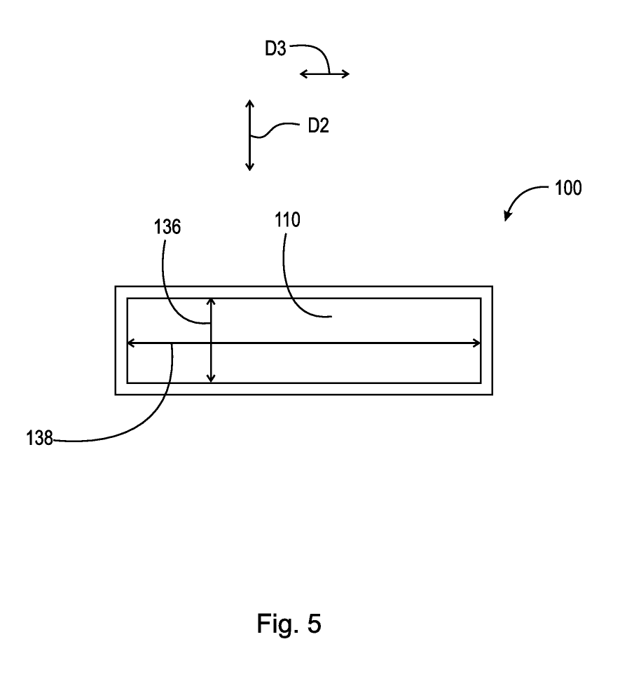

FIG. 5 is a front view of the nozzle in FIG. 1 showing an exit orifice. The following should be viewed in light of FIGS. 1 through 5. Nozzle 100 includes chambers 102 and 104 and throat 106 linking chambers 102 and 104. Chamber 102 includes orifice 108 arranged for connection to a source of gas G, for example, tube T. Chamber 104 includes exit orifice 110 arranged to emit gas G in gas stream, or flow, GS. Chamber 102 tapers from orifice 108 to throat 106 and chamber 104 expands in size from throat 106 to orifice 110.

Nozzle 100 includes longitudinal axis LA extending in direction D1 from orifice 108 to orifice 110 through chambers 102 and 104 and throat 106. In an example embodiment as shown in FIG. 3, chamber 102 tapers in direction D2, orthogonal to direction D1 and, as shown in FIG. 4, a size of chamber 102 in direction D3, orthogonal to the directions D2 and D3, is substantially uniform. That is, distance 112 between top surface 114 and bottom surface 116 of chamber 102 decreases moving in direction D1 and distance 118 between sides wall 120 and 122 of chamber 102 remains substantially uniform (unchanging) between orifice 108 and throat 106.

In an example embodiment as shown in FIG. 3, chamber 104 expands in direction D2 and, as shown in FIG. 4, a size of chamber 104 in direction D3 is substantially uniform. That is, distance 124 between top surface 126 and bottom surface 128 of chamber 104 increases moving in direction D1 and distance 130 between sides wall 132 and 134 of chamber 104 remains substantially uniform (unchanging) between throat 106 and orifice 110.

In an example embodiment, height 136 of orifice 110 in direction D2 is less than width 138 of orifice 110 in direction D3. That is, orifice 110 has a rectangular shape in a plane defined by directions D2 and D3. It should be understood that a configuration and shape of orifice 110 is not limited to the configuration and shape shown in FIG. 5 and that other configurations and shapes are possible. For example, the angular corners shown in FIG. 5 can be rounded and the continuous straight lines shown in FIG. 5 can be rounded and/or made discontinuous.

In an example embodiment, maximum dimension, or length, 140 for chamber 104 in direction D1 is greater than maximum dimension, or length, 142 for chamber 102 in direction D1. In an example embodiment, maximum height 124 for chamber 104 is greater than maximum height, 112 for chamber 102.

In an example embodiment, gas stream GS reaches supersonic speed in chamber 104.

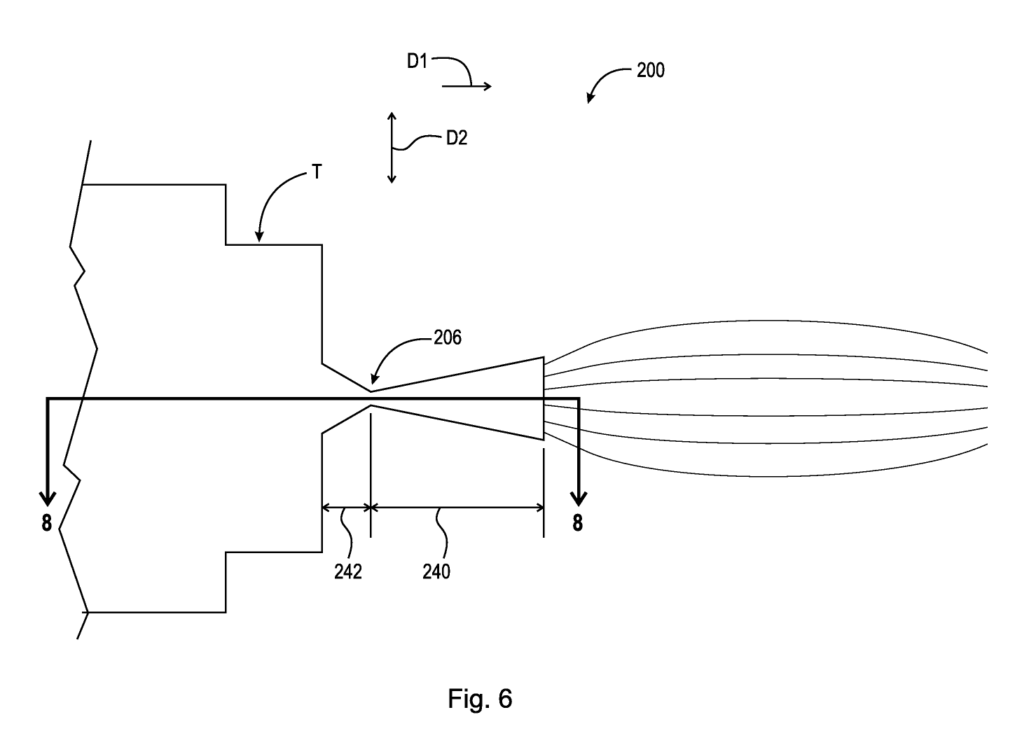

FIG. 6 is a top view of nozzle 200 for producing a controlled gas stream in a low pressure environment.

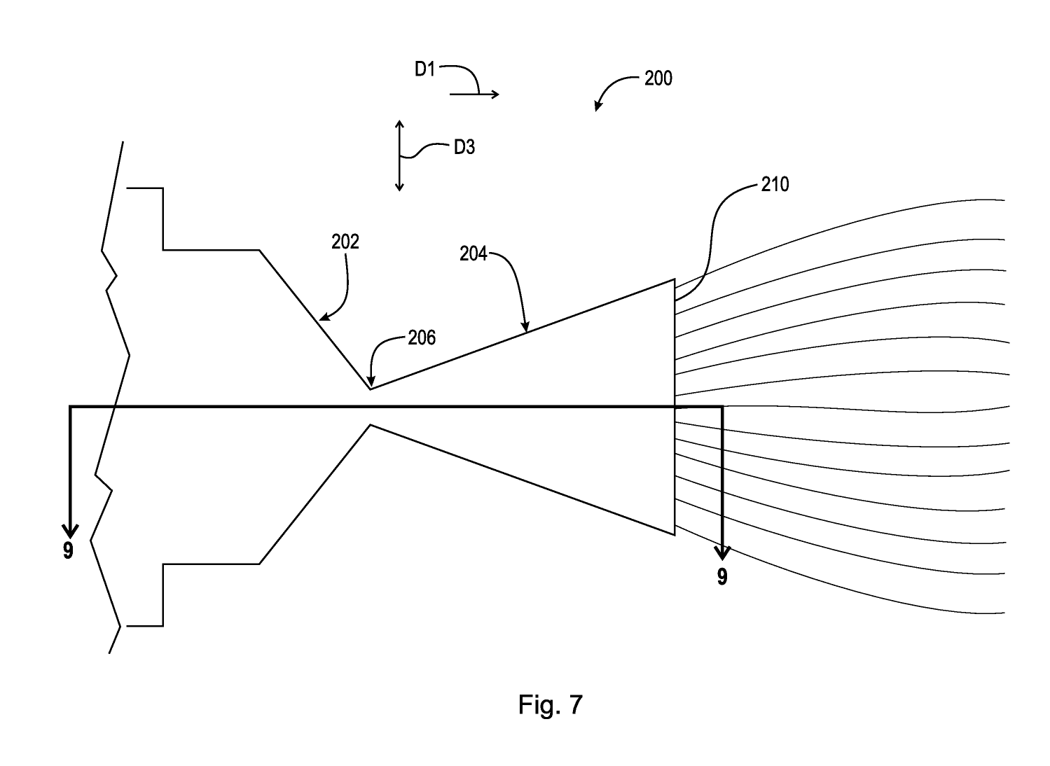

FIG. 7 is a side view of nozzle 200 in FIG. 6.

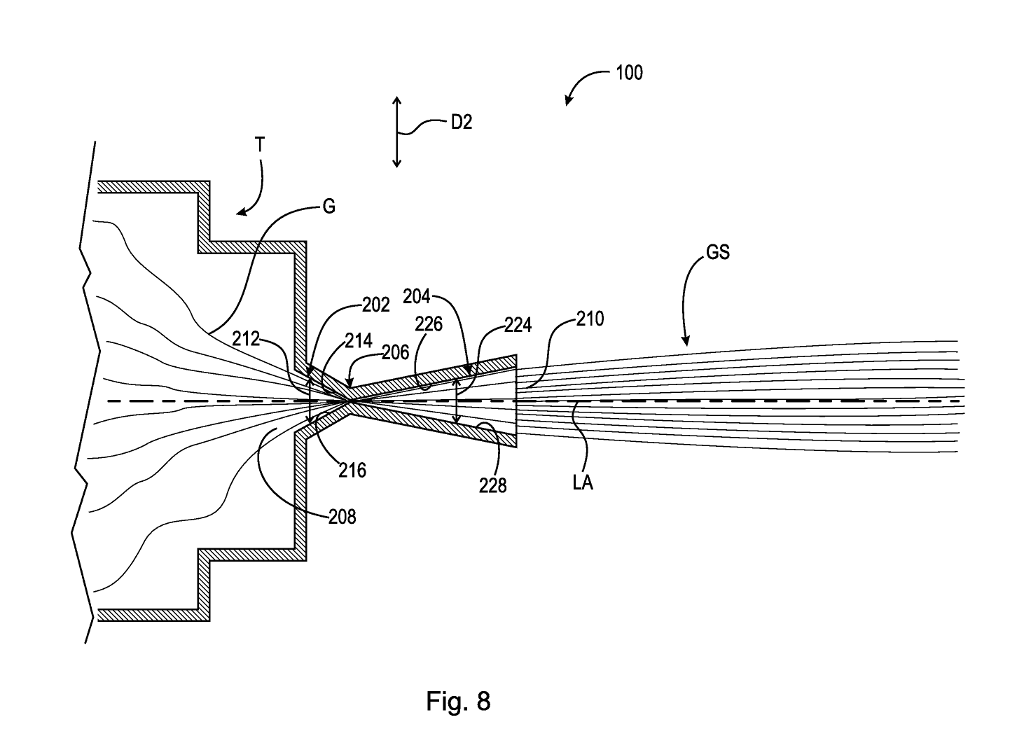

FIG. 8 is cross-sectional view generally along line 8-8 in FIG. 6.

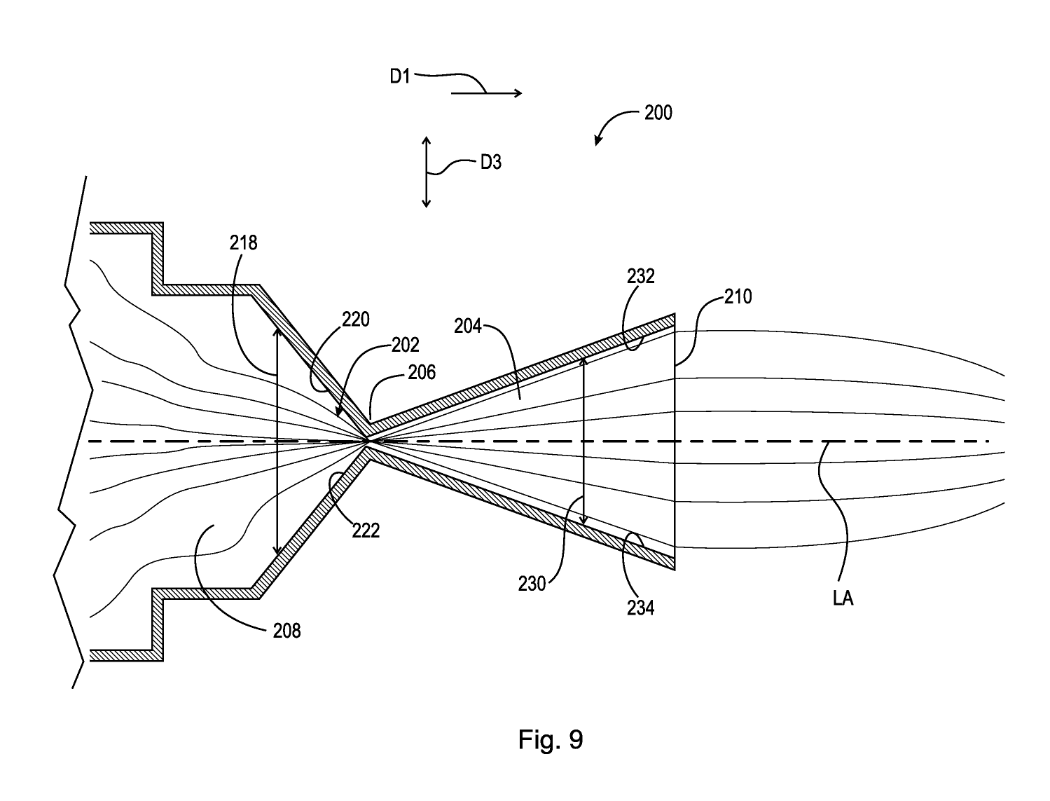

FIG. 9 is a cross-sectional view generally along line 9-9 in FIG. 7.

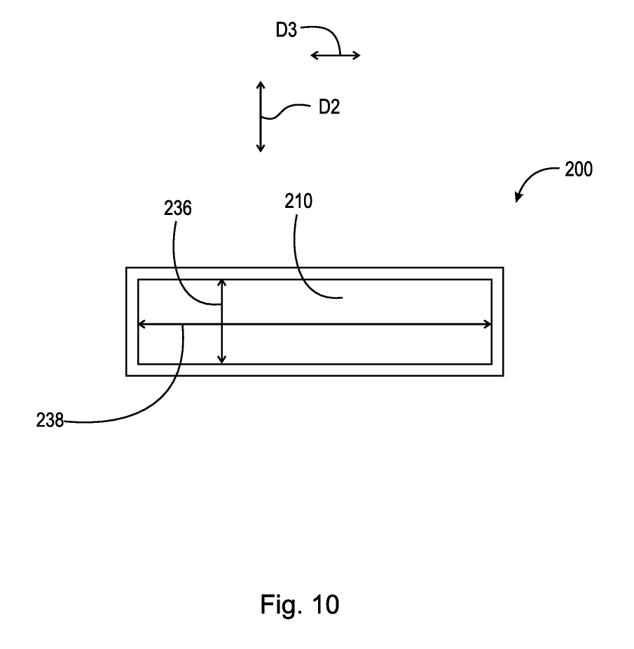

FIG. 10 is a front view of the nozzle in FIG. 6 showing an exit orifice. The following should be viewed in light of FIGS. 6 through 10. Nozzle 200 includes chambers 202 and 204 and throat 206 linking chambers 202 and 204. Chamber 202 includes orifice 208 arranged for connection to a source of gas G, for example, tube T. Chamber 204 includes exit orifice 210 arranged to emit gas stream, or flow, GS. Chamber 202 tapers from orifice 208 to throat 206 and chamber 204 expands in size from throat 206 to orifice 210.

Nozzle 200 includes longitudinal axis LA extending in direction D1 from orifice 208 to orifice 210 through chambers 202 and 204 and throat 206. In an example embodiment as shown in FIG. 8, chamber 202 tapers in direction D2 and, as shown in FIG. 9, chamber 202 tapers in direction D3. That is, distance 212 between top surface 214 and bottom surface 216 of chamber 202 decreases moving in direction D1 and distance 218 between side wall 220 and 222 of chamber 202 decreases moving in direction.

In an example embodiment as shown in FIG. 8, chamber 204 expands in direction D2 and, as shown in FIG. 9, chamber 204 also expands in direction D3. That is, distance 224 between top surface 226 and bottom surface 228 of chamber 204 increases moving in direction D1 and distance 230 between side wall 232 and 234 of chamber 104 also increases moving in direction D1.

In an example embodiment, height 236 of orifice 210 in direction D2 is less than width 238 of orifice 210 in direction D3. That is, orifice 210 has a rectangular shape in a plane defined by directions D2 and D3. It should be understood that a configuration and shape of orifice 210 is not limited to the configuration and shape shown in FIG. 10 and that other configurations and shapes are possible. For example, the angular corners shown in FIG. 10 can be rounded and the continuous straight lines shown in FIG. 10 can be rounded and/or made discontinuous.

In an example embodiment, maximum dimension, or length, 240 for chamber 204 in direction D1 is greater than maximum dimension, or length, 242 for chamber 202 in direction D1. In an example embodiment, maximum dimension, or height, 244 for chamber 104 in direction D2 is greater than maximum dimension, or height, 246 for chamber 202 in direction D2.

In an example embodiment, gas stream GS reaches supersonic speed in chamber 204.

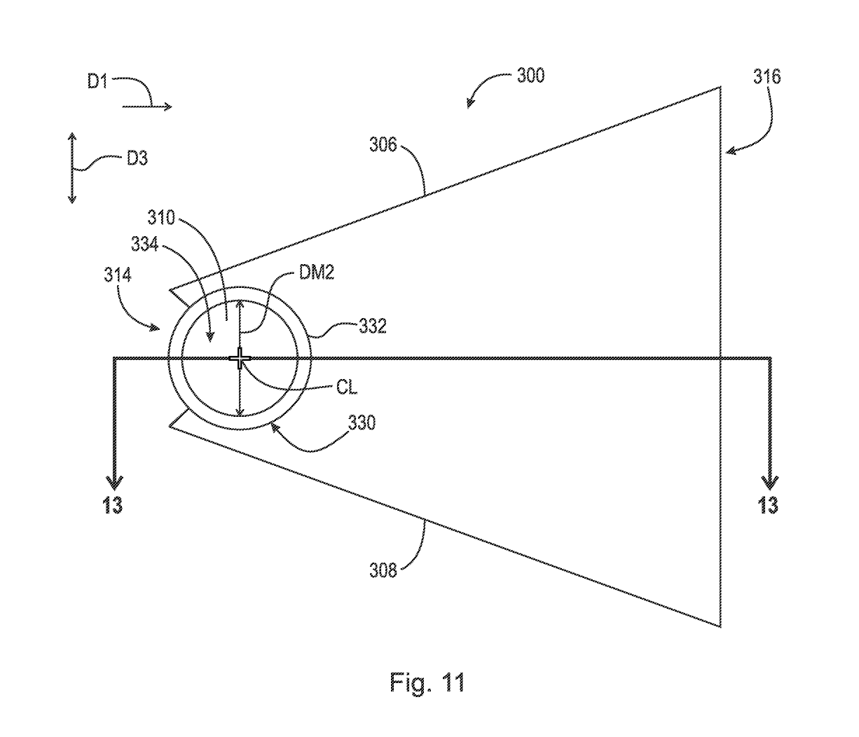

FIG. 11 is a top view of collector 300 for entraining and ejecting debris in a gas flow for a low pressure system.

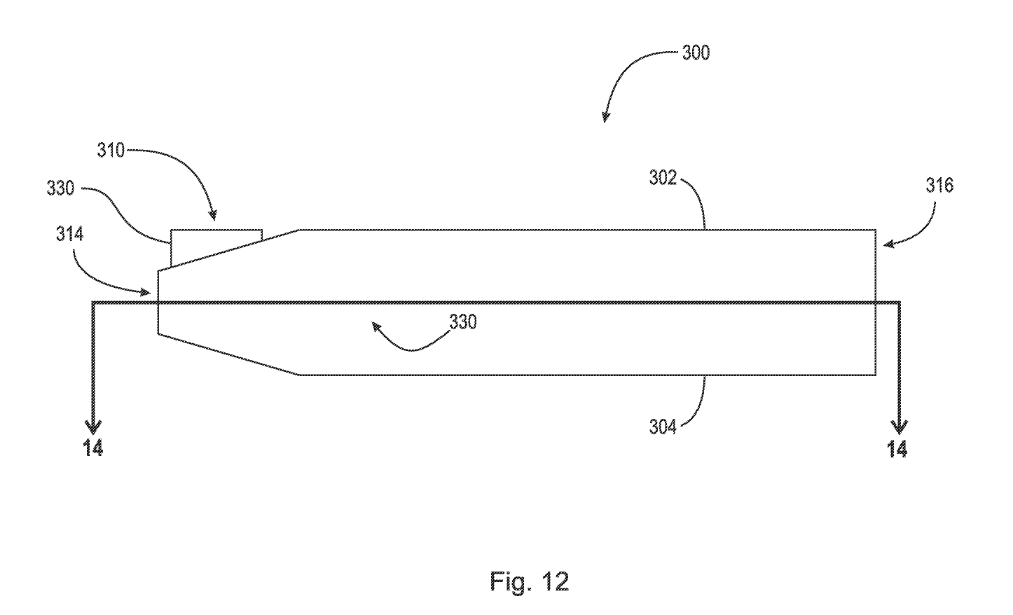

FIG. 12 is a side view of collector 300 in FIG. 11.

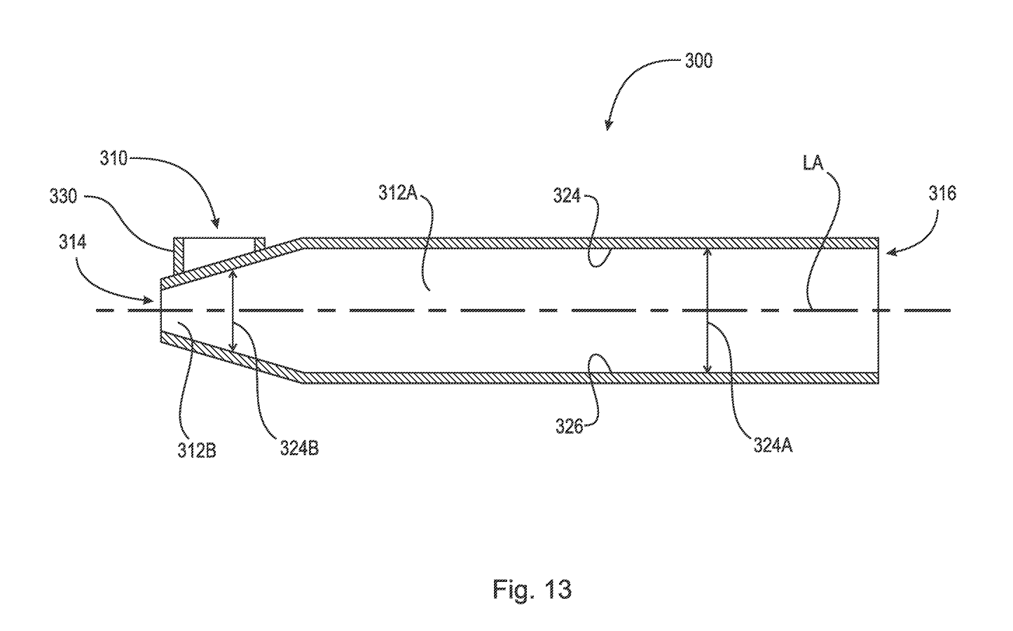

FIG. 13 is cross-sectional view generally along line 13-13 in FIG. 11.

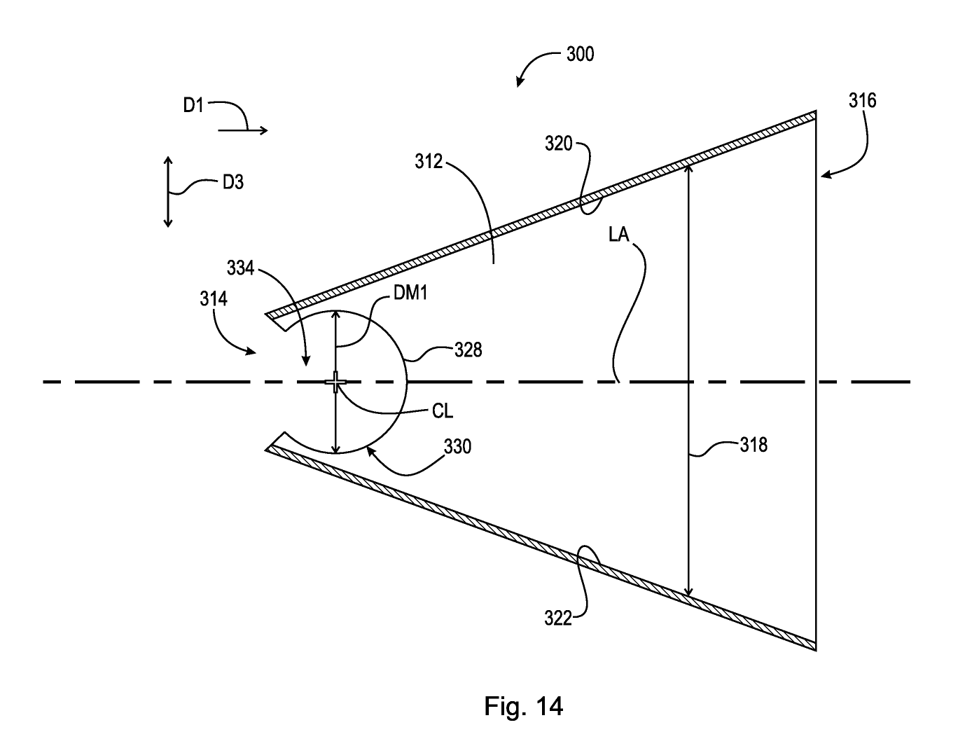

FIG. 14 is a cross-sectional view generally along line 14-14 in FIG. 12. The following should be viewed in light of FIGS. 11 through 14. Collector 300 includes top wall 302, bottom wall 304, and side walls 306 and 308 connecting top wall 302 and bottom wall 304. Collector 300 opening 310 in top wall 302 and chamber 312 formed wholly or at least partly by walls 302, 304, 306, and 308. Chamber 312 includes opening 314 and opening 316. Chamber 312 expands in size from opening 314 to opening 316. Chamber 312 is arranged to accept a gas stream, or flow to entrain, in the gas, debris entering chamber 312 through opening 310 and eject the gas, with entrained debris, from opening 316.

Collector 300 includes longitudinal axis LA extending in direction D1 from opening 314 to opening 316 through chamber 312. In an example embodiment as shown in FIG. 13, a size of chamber 312 in direction D2 is substantially uniform for portion 312A of chamber 312 and chamber 312 expands in direction D3 as shown in FIG. 14. That is, distance 318 between side walls 320 and 322 of chamber 312 increases moving in direction D1 and distance 324A between top wall 324 and bottom wall 326 of portion 312A remains substantially uniform (unchanging) between openings 314 and 316.

In an example embodiment as shown in FIG. 13, a size of chamber 312 in direction D2 is expands for portion 312B of chamber 312 and chamber 312 expands in direction D3 as shown in FIG. 14. That is, distance 318 between side walls 320 and 322 of chamber 312 increases moving in direction D1 and distance 324B between top wall 324 and bottom wall 326 of portion 312B increases in direction D1.

In an example embodiment, bottom wall 304 includes opening 328. At least respective portions of openings 310 and 328 are aligned in direction D2. In an example embodiment, an entirety of opening 310 is aligned with opening 328 in direction D2. In an example embodiment, diameter DM1 of opening 328 is larger than diameter DM2 of opening 310 to accommodate cone-shaped a light beam passing through the collector. In an example embodiment, openings 310 and 328 have common center line CL.

In an example embodiment, collector 300 includes collar 330 extending from edge 332 opening 310 in direction D2. Collar 330 is arranged to create a seal with an opening for a partition plate separating collector 300 from another chamber as discussed below.

In an example embodiment, openings 310 and 328 are only partially enclosed by walls 302 and 304, respectively. For example, gap 334 is present to accommodate a nozzle, such as nozzle 100.

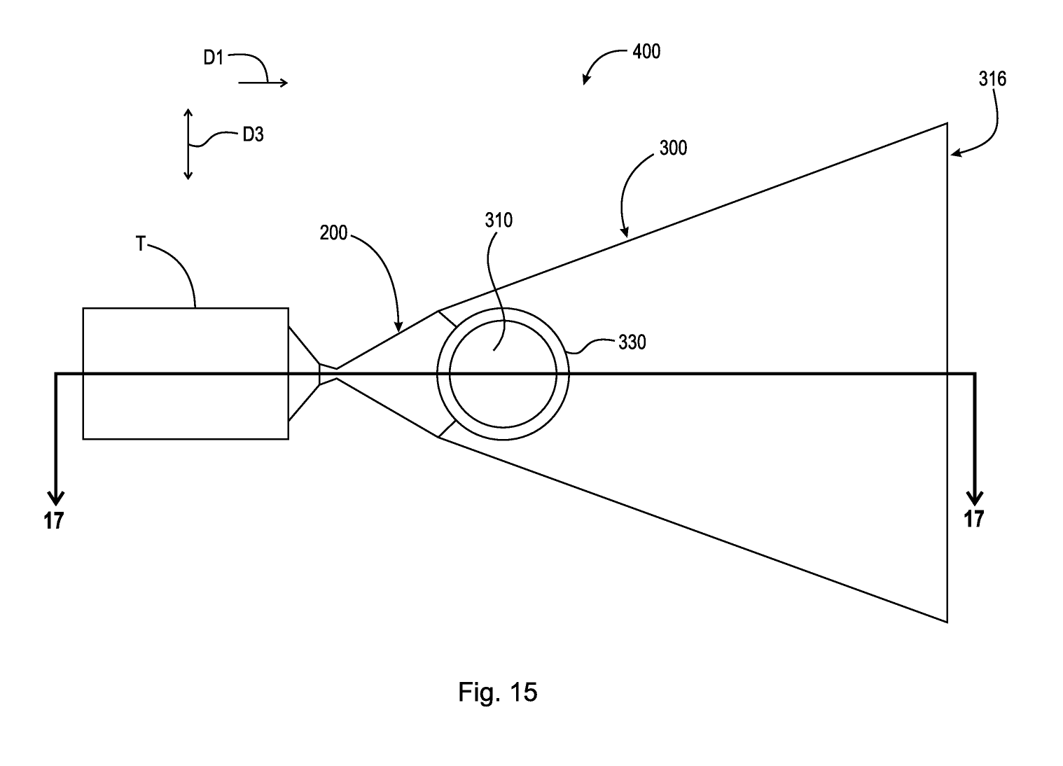

FIG. 15 is a top view of assembly 400 for mitigating contamination in a low pressure environment.

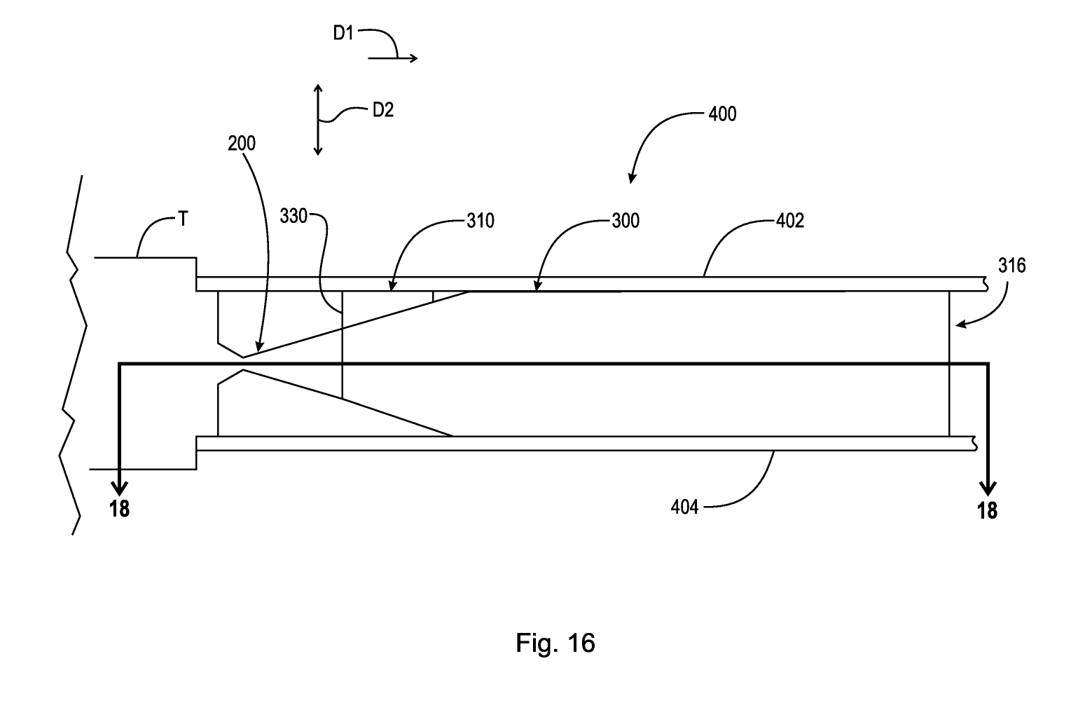

FIG. 16 is a side view of assembly 400 in FIG. 15.

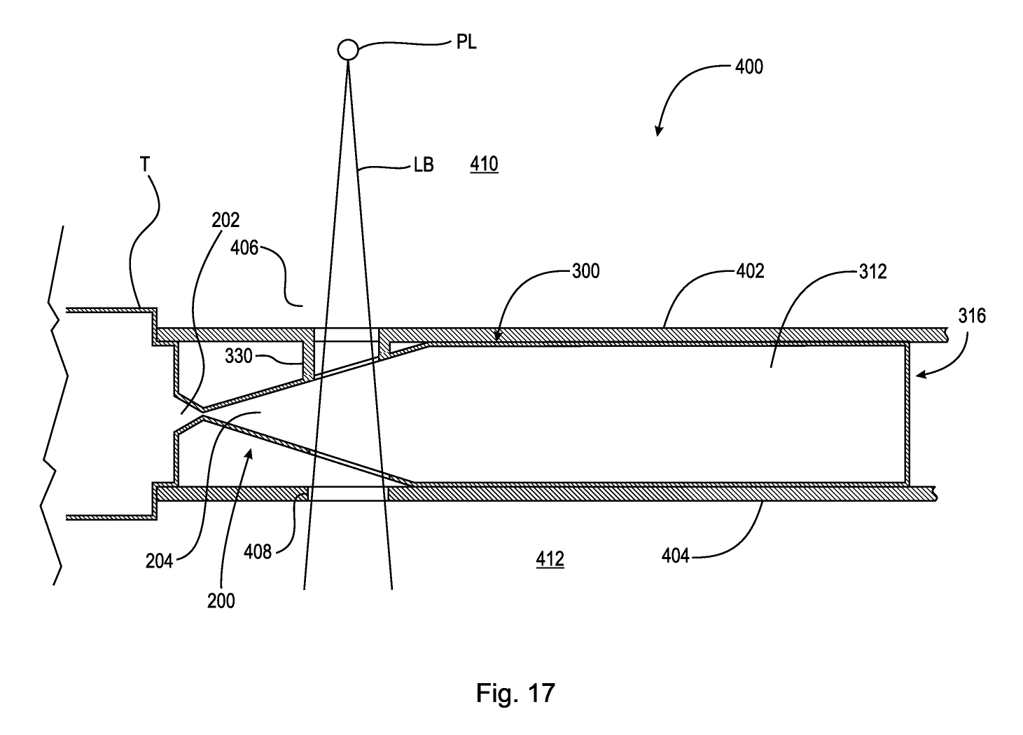

FIG. 17 is cross-sectional view generally along line 17-17 in FIG. 15.

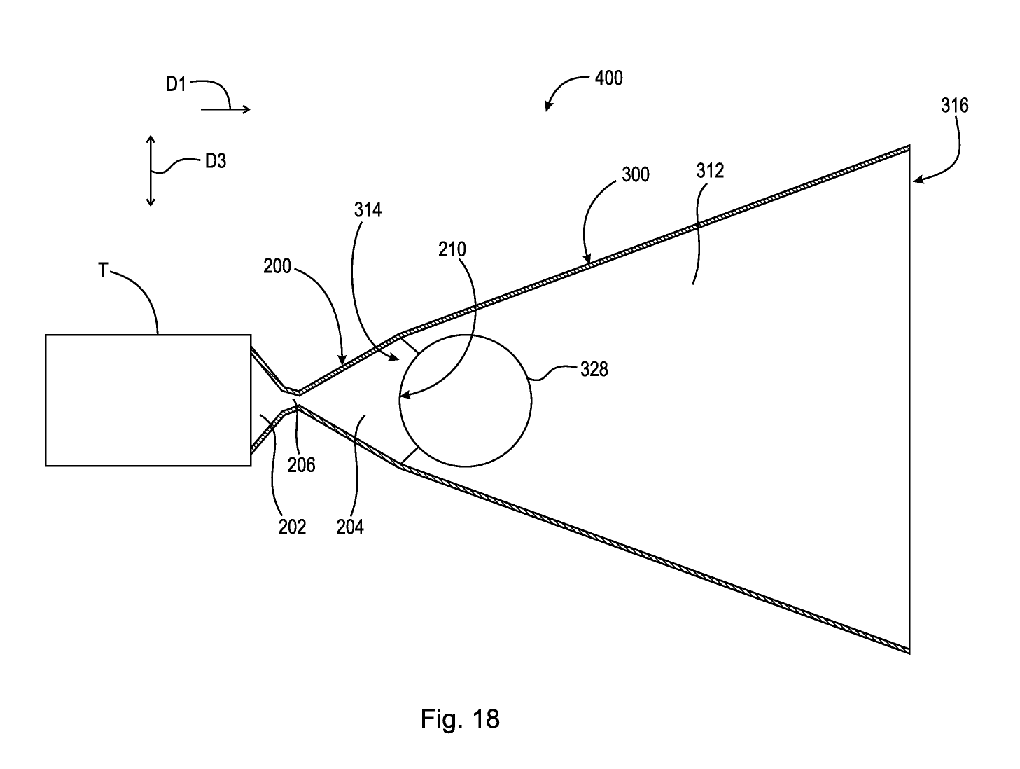

FIG. 18 is a cross-sectional view generally along line 16-16 in FIG. 15. The following should be viewed in light of FIGS. 15 through 18. Assembly 400 includes nozzle 100 or 200 and collector 200. Nozzle 200 is shown in FIGS. 15-18; however, it should be understood that the discussion of FIGS. 15-18 is applicable, unless stated otherwise, to assembly 400 with nozzle 100. Orifice 210 of nozzle 200 is connected to opening 314 of collector 300.

In an example embodiment, assembly 400 includes partition plates 402 and 404 (not shown in FIG. 15) with openings 406 and 408, respectively. Collector 300 is located between plates 402 and 404 in direction D2. At least respective portions of openings 310, 328, 406, and 408 are aligned in direction D2 In an example embodiment, respective diameters for openings 404, 310, 328, and 406 become progressively larger in the preceding sequence to accommodate cone-shaped light beam LB passing through the collector. In an example embodiment, openings 310, 328, 406, and 408 have common center line CL.

In an example embodiment, plates 402 and 404 are substantially parallel in a plane formed by directions D1 and D3. In an example embodiment, plates 402 and 404 are in contact with walls 302 and 304, respectively, and co-planar with walls 302 and 304, respectively.

In an example embodiment, plasma source PL is located in chamber 410 partially formed by plate 402 and optical components (not shown) are located in chamber 412 partially formed by plate 404. For example, the optical components are for a semi-conductor inspection system. In an example embodiment, pressure in chamber 410 is controlled independent of system 400. For example, chamber 410 contains a buffer gas, such as argon, and pressure in chamber 410 is controlled by a vacuum pump (not shown).

The dimensions and proportions of nozzles 100 and 200, as well as the pressure of gas G entering nozzles 100 and 200 are selectable to obtain a desired flow rate and flow pattern of gas G from nozzles 100 and 200, for example, into collector 200 in assembly 300. The discussion below is directed to assembly 300; however, it should be understood that portions of the discussion directed to nozzles 100 and 200 and collector 200 also are applicable to nozzles 100 and 200 and collector 200 outside of assembly 300.

In an example embodiment as shown in FIG. 18, the nozzle orifice, for example orifice 210, and opening 314 for chamber 300 have complementary curved shapes.

As noted above, plasma sources are used to generate light, such as EUV for use in semi-conductor applications, such as semi-conductor inspection systems in low pressure environments. However, a by-product of the light generation is debris that can migrate into sensitive portions of an inspection system, for example, degrading light quality or contaminating optical components. Thus, the debris adversely impacts the function and service life of the optical components and/or requires more frequent purging of the inspection system, all of which are undesirable. Advantageously, assembly 300 provides a means for entraining and removing such debris as described above and further below.

In some instances, it is desirable to generate a gas flow pattern, in direction D1, into collector 200 expanding in direction D2 and remaining substantially uniform in direction D3. Nozzle 100 provides such a flow pattern as shown in FIGS. 1 and 2. For example, as shown in FIG. 1, extent 148 of stream GS in direction D3 is substantially equal to width 138 of exit orifice 110. Further, as shown in FIG. 2, extent 150 of stream GS in direction D2 expands as the flow moves in direction D1 into the collector.

In some instances, it is desirable to generate a gas flow pattern, in direction D1, into collector 200 expanding in direction D3 and remaining substantially uniform in direction D2. Nozzle 200 provides such a flow pattern as shown in FIGS. 6 and 7. For example, as shown in FIG. 6, extent 248 of stream GS in direction D3 expands as the flow moves in direction D1 into the collector. Further, as shown in FIG. 7, extend 250 of stream GS is substantially equal to height 236 of exit orifice 210. In an example embodiment, extent 248 matches the expansion of collector 200, along direction D1, in direction D3, for example, flowing along side walls 306 and 308 with nominal contact with walls (to preserve the velocity of the gas and prevent turbulence). In an example embodiment, extent 250 matches extent 324 of the collector and gas G flows along top wall 302 and bottom wall 304 with nominal contact with walls (to preserve the velocity of the gas and prevent turbulence). Thus, the gas stream through the chamber is controlled and the gas stream is directed to where gas flow is most needed and useful. Minimizing the extent of the gas stream in direction D2 enables use of collector 400 with a minimal dimension in direction D2, advantageously reducing the space needed for system 400.

It should be understood that any gas or combination of gases known in the art can be used with system 400.

The following are example advantages of system 400:

1. Nozzles 100 and 200 shape supersonic gas flows at low Reynolds number regimes (R˜1,000) in vacuum by shaping the dimensions of chambers 102, 104, 202, and 204 and throats 106 and 206.

2. Nozzles 100 and 200 reduce condensation in some gases and assist in the acceleration of heavy gases. For example, nozzle 100 can be heated before or after throat 106 and nozzle 200 can be heated before or after throat 206 to reduce or eliminate condensation.

3. A shape of collector 400 collects a high fraction of curtain gas, for example from nozzles 100 and 200 such that the collector itself becomes a pump.

4. Stops debris and undesirable gas species from passing through an opening, such as opening 310 for passing a light beam, while minimizing absorption of light by the entraining gas and minimizing the development of larger gas pressures in regions near the gas curtain.

5. The shape of the gas stream produced, for example, by nozzle 200 (narrowly focused in direction D2 and spreading in direction D3) enables the size of openings 310 and 328 (for passing a light beam) to be minimized, further reducing the transmission path for debris to enter the chamber.

6. System 400 shapes a gas stream with minimal undesirable impact on gas pressures outside of the curtain. For example, stream GS can be such that there is little or no flow into chamber 410, which is a relatively closed area, improving EUV transmission.

7. System 400 shapes a gas stream with minimal undesirable impact on gas pressures outside of the curtain. For example, stream GS can be such that there is little or no flow into chamber 414, which is a relatively open area, improving EUV transmission.

8. Collector 300 enables collection of the gas stream and entrained debris (at opening 316) while gas G has a relatively large density, enabling easier removal of the gas and entrained debris.

9. The design gas collector 300 prevents a gas species located on one side of system 400, for example, in chamber 410, from diffusing around system 400 to the other side of system 400, for example, to chamber 414.

10. The complimentary designs of nozzles 100/200 and collector 300 eliminate dead space in the collector, for example as described above for nozzle 200 and collector 300.

11. The complimentary designs of nozzles 100/200 and collector 300 closely matches a shape of the high-speed region of stream GS such that the entire volume of the collector is continually swept by the gas flowing through the collector, for example as described above for nozzle 200 and collector 300.

12. To affect and/or control the flow rate of buffer gas, for example in chamber 410, and the distribution of the buffer gas in the chamber, the gas pressure in system 400 can be controlled. For example, increasing gas pressure in system 400 reduces the flow rate of buffer gas from chamber 410 into collector 300.

13. To affect and/or control the flow rate of buffer gas, for example in chamber 410, and the distribution of the buffer gas in the chamber, the respective temperatures of the buffer gas in chamber 410 and gas G in system 400 can be controlled.

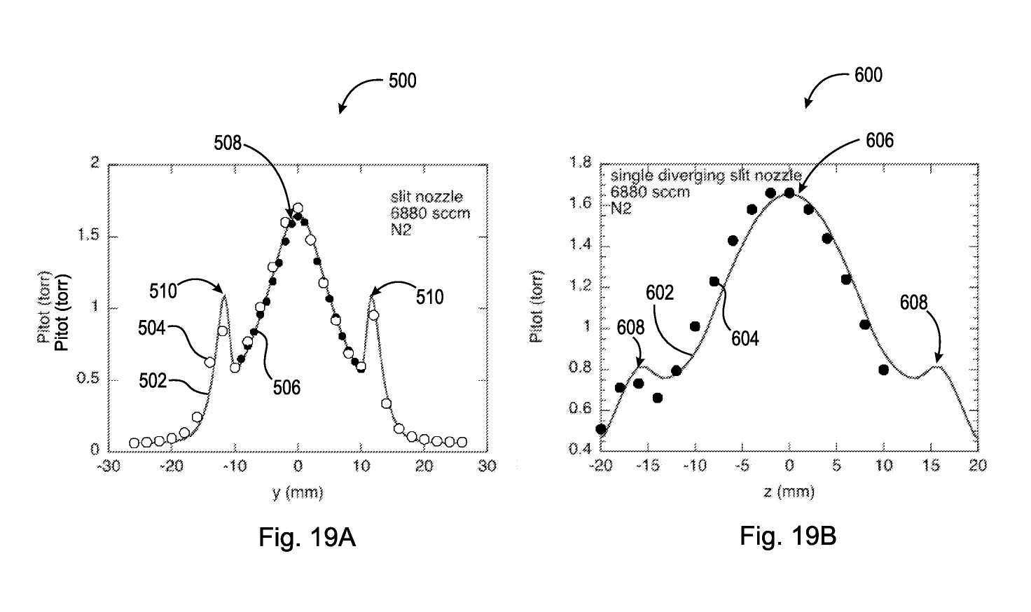

FIGS. 19A and 19B are graphs 500 and 600, respectively, showing calculated and actual performance of nozzle 100 in FIGS. 1 through 5. FIGS. 19A and 19B are for nozzle 100 having a rectangular orifice 110 (wider in direction D3). FIGS. 19A and 19B depict gas velocity values in direction D1 taken 3 centimeters away from nozzle 100 in direction D1. Lines 502 and 602 are calculated values. Points 504, 506, and 604 are actual, measured values. The vertical axes in FIGS. 19A and 19B are velocity of gas G as measured by a Pitot tube. The horizontal axis in FIG. 19A is distance in direction D3 and the horizontal axis in FIG. 19B is distance in direction D2.

FIGS. 19A and 19B show that peak velocities 508 and 606 are substantially aligned in direction D1 with a center point (in the D2/D3 plane) of orifice 110, for example, along axis LA. Lesser peak velocities 510 are symmetrically disposed from peak 508. Lesser peak velocities 608 are symmetrically disposed from peak 606. Thus, nozzle 100 produces a dual-conical gas stream focused about axis LA.

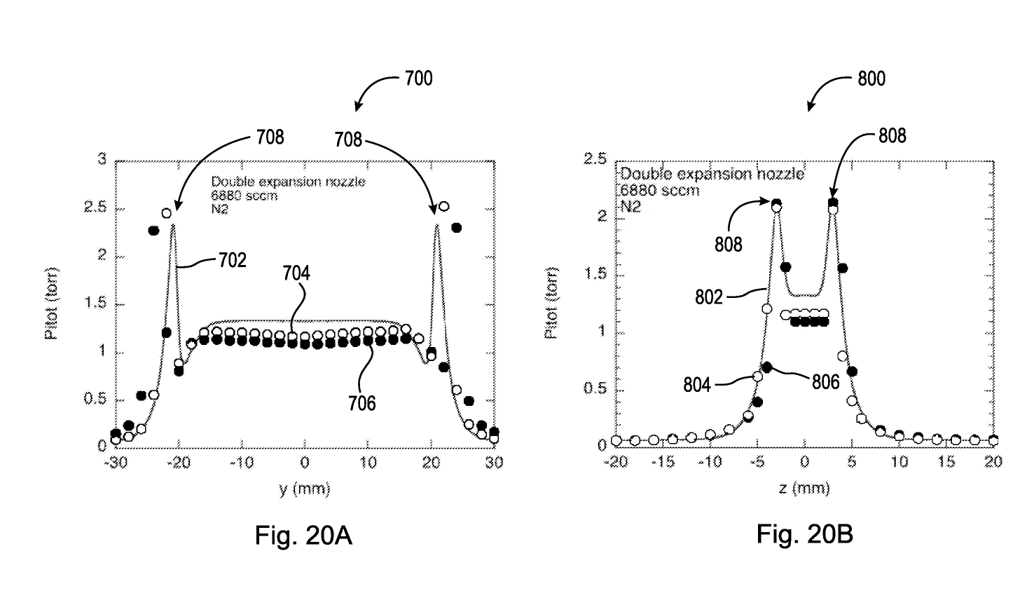

FIGS. 20A and 20B are graphs 700 and 800, respectively, showing calculated and actual performance of nozzle 200 in FIGS. 6 through 10. FIGS. 20A and 20B are for nozzle 200 having a rectangular orifice 210 (wider in direction D3). FIGS. 20A and 20B depict gas velocity values taken 3 centimeters away from nozzle 200 in direction D1. Lines 702 and 802 are calculated values. Points 704 and 706, and points 804 and 806 are actual, measured values. The vertical axes in FIGS. 20A and 20B are velocity of gas G as measured by a Pitot tube. The horizontal axis in FIG. 20A is distance in direction D3 and the horizontal axis in FIG. 20B is distance in direction D2.

FIGS. 20A and 20B show that peak velocities 708 and 808 are substantially symmetrically displaced from a center point (in the D2/D3 plane) of orifice 210, for example, about axis LA. Thus, nozzle 200 produces a gas stream with a relatively small extent in direction D2 and a larger extent in direction D3, for example, a gas stream well suited to fill collector 300 while maintaining peak velocities close to the walls of collector 300.

FIGS. 19A, 19B, 20A, and 20B each show excellent correlation between calculated and measured results, thus providing empirical evidence for the characteristics described above for nozzles 100 and 200, collector 300, and system 400.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

1. A nozzle for producing a controlled gas stream in a low pressure environment, comprising:
a first chamber with a first orifice arranged for connection to a source of gas and to receive a stream of gas from the source;
a second chamber with a second orifice arranged to emit the stream;
a throat connecting the first and second chambers; and,
a longitudinal axis extending from the first orifice to the second orifice in a first direction, wherein:
the first chamber tapers from the first orifice to the throat; and,
the second chamber expands in size from the throat to the second orifice.

2. The nozzle of claim 1, wherein:
the first chamber tapers, along the first direction, in a second direction, orthogonal to the first direction; and,
a size of the first chamber in a third direction, orthogonal to the first and second directions, is substantially uniform.

3. The nozzle of claim 1, wherein the first chamber tapers along the first direction:
in a second direction, orthogonal to the first direction; and,
in a third direction, orthogonal to the first and second directions.

4. The nozzle of claim 1, wherein:
the second chamber tapers, along the first direction, in a second direction, orthogonal to the first direction; and,
a size of the second chamber in a third direction, orthogonal to the first and second directions, is substantially uniform.

5. The nozzle of claim 1, wherein the second chamber tapers along the first direction:
in a second direction, orthogonal to the first direction; and,
in a third direction, orthogonal to the first and second directions.

6. The nozzle of claim 1, wherein:
a height of the second orifice in a second direction orthogonal to the first direction is less than a width of the fourth orifice in a third direction, orthogonal to the first and second directions.

7. The nozzle of claim 6, wherein the second orifice has a shape of a rectangle in a plane defined by the second and third directions.

8. The nozzle of claim 1, wherein the nozzle is arranged to emit the stream with:
a substantially uniform extent in a second direction orthogonal to the first direction; and,
an increasing extent along the first direction in a third direction, orthogonal to the first and second directions.

9. The nozzle of claim 1, wherein:
the longitudinal axis bisects the second orifice in second direction orthogonal to the first direction and in a third direction, orthogonal to the first and second directions;
the nozzle is arranged to emit the stream with:
a first maximum velocity, in the first direction along a plane formed by the first and second directions, at first and second points substantially equidistant from the longitudinal axis in the second direction; and,
a second maximum velocity, in the first direction along a plane formed by the first and third directions, at third and fourth points substantially equidistant from the longitudinal axis in the third direction; and,
a velocity of the stream, in the first direction, along the longitudinal axis is less than the first and second maximum velocities.

10. The nozzle of claim 1, wherein:
the longitudinal axis bisects the second orifice in second direction orthogonal to the first direction and in a third direction, orthogonal to the first and second directions;
the nozzle is arranged to emit the stream with:
a maximum velocity, in the first direction, along the longitudinal axis;
a first velocity, in the first direction along a plane formed by the first and second directions, decreasing in the second direction; and,
a second velocity, in the first direction along a plane formed by the first and third directions, decreasing in the third direction.

11. The nozzle of claim 1, wherein a maximum dimension for the second chamber in the first direction is greater than a maximum dimension for the first chamber in the first direction.

12. The nozzle of claim 1, wherein a maximum dimension for the second chamber in a second direction, orthogonal to the first direction, is greater than a maximum dimension for the first chamber in the second direction.

13. The nozzle of claim 1, wherein:
an area of the first orifice, in a second direction orthogonal to the first direction and in a third direction orthogonal to the first and second directions, is less than an area of the throat in the second and third directions.

14. The nozzle of claim 1, wherein:
an area of the throat, in a second direction orthogonal to the first direction and in a third direction orthogonal to the first and second directions, is less than an area of the second orifice in the second and third directions.

15. A collector for entraining and ejecting debris in a gas flow for a low pressure system, comprising:
a top wall, a bottom wall, and first and second side walls connecting the top and bottom walls;
first and second openings in the top and bottom walls, respectively;
a first chamber:
formed by the top wall, the bottom wall, and the first and second side walls;
including:
a third opening arranged to receive a stream of gas; and,
a fourth opening; and,
expanding in size from the first opening to the second opening; and,
a longitudinal axis extending in a first direction from the third opening to the fourth opening, wherein:
the collector is arranged to:
entrain, in the stream, debris entering the first chamber through the first or second opening; and,
emit the stream, with the entrained debris, from the fourth opening.

16. The collector of claim 15, wherein:
the first chamber expands, along the first direction, in a second direction, orthogonal to the first direction; and,
a size of a portion of the first chamber in a third direction, orthogonal to the first and second directions, is substantially uniform.

17. The collector of claim 15, wherein:
the first chamber expands, along the first direction, in a second direction, orthogonal to the first direction; and,
a portion of the first chamber expands, along the first direction, in a third direction, orthogonal to the first and second directions.

18. The collector of claim 15, wherein at least respective portions of the first and second openings are aligned in a second direction, orthogonal to the first direction.

19. The collector of claim 15, wherein:
the first opening has a first diameter; and,
the second opening has a second diameter, greater than the first diameter, to accommodate a cone-shaped light beam passing through the first chamber.

20. The collector of claim 15, further comprising:
a collar extending from the top wall in a second direction, orthogonal to the first direction, and at least partially surrounding the first opening, wherein:
the collar is arranged to create a seal with a fifth opening for a partition plate separating the collector from a second chamber.

21. An assembly for removing debris from a controlled pressure environment, comprising:
a nozzle including:
a first chamber with a first orifice arranged for connection to a source of gas and to receive a stream of gas from the source;
a second chamber with a second orifice arranged to emit the stream;
a throat connecting the first and second chambers;
a collector including:
top and bottom walls with first and second openings, respectively;
a third chamber bounded in part by the top and bottom walls and including:
a third opening connected to the second orifice and arranged to receive the stream; and,
a fourth opening; and,
a longitudinal axis passing through the first and second orifices and the third and fourth openings in a first direction, wherein:
the first chamber tapers from the first orifice to the throat;
the second chamber expands in size from the throat to the second orifice;
the third chamber expands in size from the third opening to the fourth opening;
the collector is arranged to:
entrain, in the stream, debris entering the third chamber through first or second opening; and,
emit the stream, with the entrained debris, from the fourth opening.

22. The assembly of claim 21, wherein:
the first chamber tapers, along the first direction, in a second direction, orthogonal to the first direction and a size of the first chamber in a third direction, orthogonal to the first and second directions, is substantially uniform; or,
the first chamber tapers, along the first direction, in a second direction, orthogonal to the first direction and the first chamber tapers, along the first direction, in a third direction, orthogonal to the first and second directions.

23. The assembly of claim 21, wherein:
the second chamber tapers, along the first direction, in a second direction, orthogonal to the first direction and a size of the second chamber in a third direction, orthogonal to the first and second directions, is substantially uniform; or,
the second chamber tapers, along the first direction, in a second direction, orthogonal to the first direction and the second chamber tapers, along the first direction, in a third direction, orthogonal to the first and second directions.

24. The assembly of claim 21, wherein a height of the second orifice in a second direction orthogonal to the first direction is less than a width of the second orifice in a third direction, orthogonal to the first and second directions.

25. The assembly of claim 21, wherein:
a size of a portion of the third chamber in a second direction is substantially uniform; and,
the third chamber expands, along the first direction, in a third direction, orthogonal to the first and second directions.

26. The assembly of claim 21, wherein:
a size of a portion of the third chamber, along the first direction, expands in a second direction orthogonal to the first direction; and,
the third chamber expands, along the first direction, in a third direction, orthogonal to the first and second directions.

27. The assembly of claim 21, wherein at least respective portions of the first and second openings are aligned in a second direction, orthogonal to the first direction.

28. The assembly of claim 27, wherein:
the first opening has a first diameter; and,
the second opening has a second diameter, greater than the first diameter, to accommodate a cone-shaped light beam passing through the collector.

29. The assembly of claim 21, wherein:
the collector includes a collar extending from the top wall in a second direction, orthogonal to the first direction, and at least partially surrounding the first opening; and,
the collar is arranged to create a seal with a fifth opening for a partition plate separating the collector from a second chamber.

30. The assembly of claim 21, further comprising:
first partition plate with a fifth opening; and
a second partition plate with a sixth opening, wherein:
the collector is disposed between the first and second partition plates such that at least respective portions of the first, second, fifth, and sixth openings are aligned in a second direction, orthogonal to the first direction.

31. The assembly of claim 30, wherein:
the first and second partition plates are substantially parallel;
the first partition plate is in contact with and coplanar with the top wall; and,
the second partition plate is in contact with and coplanar with the bottom wall.

32. A method for removing debris from a controlled pressure environment, comprising:
flowing gas, in a first direction, through a first chamber for a nozzle while simultaneously reducing, along the first direction, a first area, in second and third directions orthogonal to the first direction, of a stream of the gas in the first chamber;
flowing the gas through a throat connecting the first chamber to a second chamber for the nozzle;
flowing the gas, in the first direction, through the second chamber while simultaneously increasing, along the first direction, a second area, in the second and third directions, of the steam of the gas in the second chamber;
flowing the gas from the second chamber into a third chamber for a collector;
flowing the gas through the third chamber in the first direction, while simultaneously increasing, along the first direction, a third area, in the second and third directions, of the stream of the gas in the third chamber;
entraining, in the stream of the gas, debris located in the third chamber; and,
emitting, in the first direction, the stream of the gas with the entrained debris from the third chamber through a first opening of the collector.

33. The method of claim 32, further comprising:
removing, using a vacuum pump, the stream of gas, with the entrained debris, emitted from the third chamber.

34. The method of claim 32, wherein flowing the gas through the second chamber while simultaneously increasing the second area includes flowing the gas at supersonic speed.

35. The method of claim 32, wherein the debris is introduced into the third chamber through a second opening in the collector.

36. The method of claim 32, further comprising:
transmitting a beam of light through the third chamber; and,
introducing the debris with the beam of light.

37. The method of claim 32, wherein reducing the first area includes:
reducing, along the first direction, an extent of the first area in the second direction while maintaining a substantially uniform extent of the first area in the third direction; or,
reducing respective extents of the first area in the second and third directions.

38. The method of claim 32, wherein increasing the second area includes:
increasing, along the first direction, an extent of the second area in the second direction while maintaining a substantially uniform extent of the second area in the third direction; or,
increasing, along the first direction, respective extents of the second area in the second and third directions.

39. The method of claim 32, wherein increasing the third area includes increasing, along the first direction, an extent of the third area in the second direction while maintaining, for a portion of the third chamber, a substantially uniform extent of the third area in the third direction.

40. The method of claim 32, wherein increasing the third area includes increasing, for a portion of the third chamber and along the first direction, an extent of the third area in the second and third directions.

41. The method of claim 32, wherein flowing the gas from the second chamber into the third chamber for the collector includes generating a stream entering the third chamber with an extent in the second direction less than an extent in the third direction.

42. The method of claim 32, wherein an extent, in the second and third directions, of the stream of the gas in the third chamber substantially matches an extent of the third chamber in the second and third directions.

43. The method of claim 32, wherein:
a longitudinal axis, in the first direction, passes through the nozzle, an orifice of the nozzle connected to the third chamber, and the third chamber;
the longitudinal axis bisects the orifice in the second and third directions; and,
flowing the gas from the second chamber into a third chamber includes flowing the gas with a maximum velocity, in the first direction, along the longitudinal axis.

44. The method of claim 32, wherein:
a longitudinal axis, in the first direction, passes through the nozzle, an orifice of the nozzle connected to the third chamber, and the third chamber;
the longitudinal axis bisects the orifice in the second and third directions; and,
flowing the gas from the second chamber into a third chamber includes flowing the gas with:
a first maximum velocity, in the first direction along a plane formed by the first and second directions, at first and second points substantially equidistant from the longitudinal axis in the second direction; and,
a second maximum velocity, in the first direction along a plane formed by the first and third directions, at third and fourth points substantially equidistant from the longitudinal axis in the third direction.

45. The method of claim 32, further comprising:
forming a fourth chamber bounded by a partition, the partition:
connected to the collector;
including a second opening; and,
extending in the first and second directions, wherein:
the collector includes a third opening connecting the third chamber to the second opening and the fourth chamber; and,
flowing the gas through the third chamber includes flowing the gas at a first pressure greater than a second pressure in the fourth chamber.

46. The method of claim 32, further comprising:
forming a fourth chamber bounded by a partition:
connected to the collector;
including a second opening; and,
extending in the first and second directions, wherein:
the collector includes a third opening connecting the third chamber to the second opening and the fourth chamber; and, the method further comprising:
controlling respective temperatures of:
the gas flowing through the third chamber; and,
a gas in the fourth chamber.

47. The method of claim 32, further comprising:
heating the first or second chamber to reduce or eliminate condensation in the stream of the gas.
